(19) United States
(12) Patent Application Publication
(10) Pub. No.: US 2020/0362935 A1
(43) Pub. Date: Nov. 19, 2020

(54) Linear motion dampening system

(71) Applicant: OZAUTOGATE PTY LTD., Brisbane, Queensland (AU)

(72) Inventor: Mathew Mario SIMONELLI, Brisbane, Queensland (AU)

(21) Appl. No.: 16/962,232

(22) PCT Filed: Jan. 15, 2019
(86) PCT No.: PCT/AU2019/050019

§ 371 Date: Jul. 15, 2020

(30) Foreign Application Priority Data
Jan. 15, 2018 (AU) 2018900109

(51) Int. Cl. F16F 9/50; F16F 9/48

(52) U.S. Cl. CPC F16F 9/50; F16F 9/3235; F16F 9/48

(57) ABSTRACT

A linear motion dampening system enables a complex non-linear force response when it is used to control cyclical motion of a mechanical element. The system includes: a ram barrel having a fluid reservoir end and a tapered end closed by an end cap; a coil spring positioned inside the ram barrel; a ram shaft having a distal end that is slidable inside the tapered end of the ram barrel, the ram shaft extending through the coil spring and outward from the fluid reservoir end of the ram barrel; and a ram piston slidably attached to the distal end of the ram shaft; wherein an inner diameter of the tapered end of the ram barrel is tapered from a greater value nearer the fluid reservoir end to a smaller value nearer the end cap.

### FIELD OF THE INVENTION

The present invention relates generally to mechanical motion dampeners, and in particular although not exclusively to combined spring and hydraulic linear motion dampening systems.

### BACKGROUND TO THE INVENTION

Various forms of linear motion dampening apparatus are well known in the art. For example, such devices are commonly used to dampen oscillatory movement of linear springs, such as in vehicle suspension systems in the automotive industry that include coil springs and shock absorbers. Linear spring plus dampener systems are also commonly used on various enclosures such as doors, hatches, swing gates and boom gates, and operate using hydraulic or pneumatic pressures.

However, prior art spring plus dampener systems generally provide only a linear force response relative to a specified direction, velocity, and/or position of the mechanical element, such as a door, that is constrained by the system. More complex mechanical elements, such as swing gates and boom gates, may operate less effectively if they are restricted by only a linear force response from a spring plus dampener system during cyclical movement of the mechanical element.

There is therefore a need for an improved linear motion dampening system.

### OBJECT OF THE INVENTION

It is an object of the present invention to overcome and/or alleviate one or more of the above described disadvantages of the prior art or provide the consumer with a useful or commercial choice.

### SUMMARY OF THE INVENTION

According to one aspect, the invention is a linear motion dampening system, comprising:

a ram barrel having a fluid reservoir end and a tapered end closed by an end cap;

a coil spring positioned inside the ram barrel;

a ram shaft having a distal end that is slidable inside the tapered end of the ram barrel, the ram shaft extending through the coil spring and outward from the fluid reservoir end of the ram barrel; and

a ram piston slidably attached to the distal end of the ram shaft;

wherein an inner diameter of the tapered end of the ram barrel is tapered from a greater value nearer the fluid reservoir end to a smaller value nearer the end cap.

Preferably, the ram shaft includes port holes extending from a side of the ram shaft to the distal end of the ram shaft, wherein in a first position the ram piston seals the port holes and in a second position the ram piston does not seal the port holes.

Preferably, a bias spring biases the ram piston in the first position that seals the port holes.

Preferably, a tapered section of the tapered end of the ram barrel extends for at least one third of a total length of the ram barrel.

Preferably, a tapered section of the tapered end of the ram barrel extends for at least one half of a total length of the ram barrel.

Preferably, a bushing is secured to the ram shaft adjacent to the ram piston.

Preferably, the coil spring is compressed by the bushing and the fluid reservoir end of the ram barrel.

Preferably, a first lug is connected to the ram shaft at the fluid reservoir end and a second lug is connected to the ram barrel at the tapered end.

Preferably, the ram piston includes at least one piston ring.

Preferably, a ram cap covers the fluid reservoir end of the ram barrel and includes a vent hole.

Preferably, the ram barrel is filled with hydraulic fluid.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 is a partial cross section view of a linear motion dampening system, according to an embodiment of the present invention;

FIG. 2 is a side perspective view of the linear motion dampening system of FIG. 1 that illustrates the cylindrical external shape of the ram barrel;

FIG. 3 is a partial cross section view of the linear motion dampening system of FIG. 1 shown in a fully closed position, where the ram shaft is fully received inside the ram barrel;

FIG. 4 is a partial cross section view of the linear motion dampening system of FIG. 1 shown as it begins to open under the force of a mechanical or electrical actuator (not shown) that begins to open an associated swing gate or boom gate (not shown);

FIG. 5 is a partial cross section view of the linear motion dampening system of FIG. 1 shown when it is fully open under the force of a mechanical or electrical actuator that has fully opened the associated swing gate or boom gate;

FIG. 6 is a partial cross section view of the linear motion dampening system of FIG. 1 shown in a fully open position and where the system is just beginning to be closed by the mechanical or electrical actuator.

### DETAILED DESCRIPTION OF THE PREFERRED EMBODIMENT

The present invention relates to a linear motion dampening system. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, top and bottom, up and down, upper and lower, rear, front and side, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the present invention is defined as a linear motion dampening system, comprising: a ram barrel having a fluid reservoir end and a tapered end closed by an end cap; a coil spring positioned inside the ram barrel; a ram shaft having a distal end that is slidable inside the tapered end of the ram barrel, the ram shaft extending through the coil spring and outward from the fluid reservoir end of the ram barrel; and a ram piston slidably attached to the distal end of the ram shaft; wherein an inner diameter of the tapered end of the ram barrel is tapered from a greater value nearer the fluid reservoir end to a smaller value nearer the end cap.

Advantages of some embodiments of the present invention include the ability to obtain a complex non-linear force response from the dampener when it is used to control cyclical motion of a mechanical element. For example, the cyclical motion of a mechanical element such as a swing gate can be controlled by a linear motion dampening system of the present invention. The system of the present invention can enable a swing gate to be rapidly opened, smoothly arrested when fully open, then enable a timed initiation of a closing of the swing gate followed by a constant speed closing motion, and finally by a smoothly arrested motion near a fully closed position. Those skilled in the art will appreciate that not all of the above advantages will be achieved by all possible embodiments of the present invention.

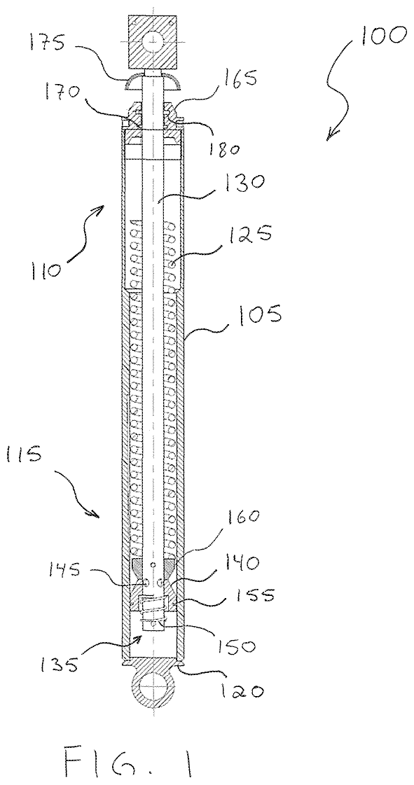

FIG. 1 is a partial cross section view of a linear motion dampening system 100, according to an embodiment of the present invention. The system 100 includes a ram barrel 105 having a fluid reservoir end 110 and a tapered end 115 closed by an end cap 120. A coil spring 125 is positioned inside the ram barrel 105. A ram shaft 130 includes a distal end 135 that is slidable inside the tapered end 115 of the ram barrel 105. The ram shaft 130 extends through the coil spring 125 and outward from the fluid reservoir end 110 of the ram barrel 105. A ram piston 140 is slidably attached to the distal end 135 of the ram shaft 130.

An inner diameter of the tapered end 115 of the ram barrel 105 is tapered from a greater value nearer the fluid reservoir end 110 to a smaller value nearer the end cap 120.

Port holes 145 are drilled into a side of the ram shaft 130 and open into a longitudinal end hole (not shown) that is drilled down a centre-line of the ram shaft 130 from the distal end 135 up to the port holes 145. Longitudinal motion of the ram piston 140 along the ram shaft 130 is biased toward the fluid reservoir end 110 by a bias spring 150. A bushing 160 is secured to the ram shaft 130 and stops longitudinal motion of the ram piston 140 along the ram shaft 130 at a position where the port holes 145 are sealed by the internal wall of the ram piston 140.

To effectively seal the external wall of the ram piston 140 against the internal wall of the ram barrel 105, a ram piston ring 155 is concentrically positioned around the external wall of the ram piston 140. As described in further detail below, the inner diameter of the ram barrel 105, which is tapered from a greater value nearer the fluid reservoir end 110 to a smaller value nearer the end cap 120, enables more fluid to flow past the ram piston ring 155 nearer the fluid reservoir end 110 and less fluid to flow past the ram piston ring 155 nearer the end cap 120.

A ram cap 165 closes the fluid reservoir end 110 of the ram barrel 105. O-rings 170 seal against the surface of the ram shaft 130 and prevent hydraulic fluid from leaking from the ram barrel 105 when the ram shaft 130 cycles in and out of the ram barrel 105. A top hat 175 protects the ram cap 165.

According to some embodiments a vent hole 180 is included in the ram cap 165 to enable pressure equalisation between the inside and the outside of the ram barrel 105 during use. In such embodiments the ram barrel 105 is generally maintained in a vertical orientation, as shown in FIG. 1, during use to prevent leaking of hydraulic fluid from the vent hole 180.

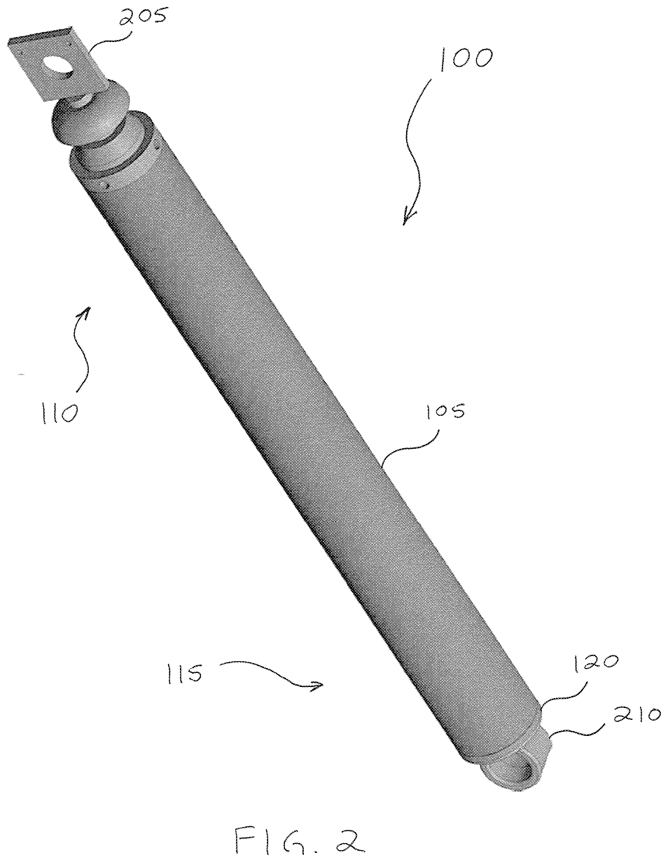

FIG. 2 is a side perspective view of the linear motion dampening system 100 that illustrates the cylindrical external shape of the ram barrel 105. As shown a square lug 205 is connected to the end of the ram shaft 130 that extends outside of the ram barrel 105, and a round lug 210 is connected to the end cap 120. As will be understood by those having ordinary skill in the art, the lugs 205, 210 can be connected to an associated apparatus by, for example, bolts, bushings or connecting rods. For example, the square lug 205 can be connected to a moveable barrier of a swing gate or boom gate (not shown) and the round lug 210 can be connected to a fixed frame (not shown), or vice versa, of the swing gate or boom gate.

The operation of swing gates and boom gates of various designs and sizes are well known in the art. For example such gates are commonly used in a horizontal closed position to provide a barrier across a road or pathway, and when opened to a vertical position the gates allow for the passage of vehicles, cattle or other traffic.

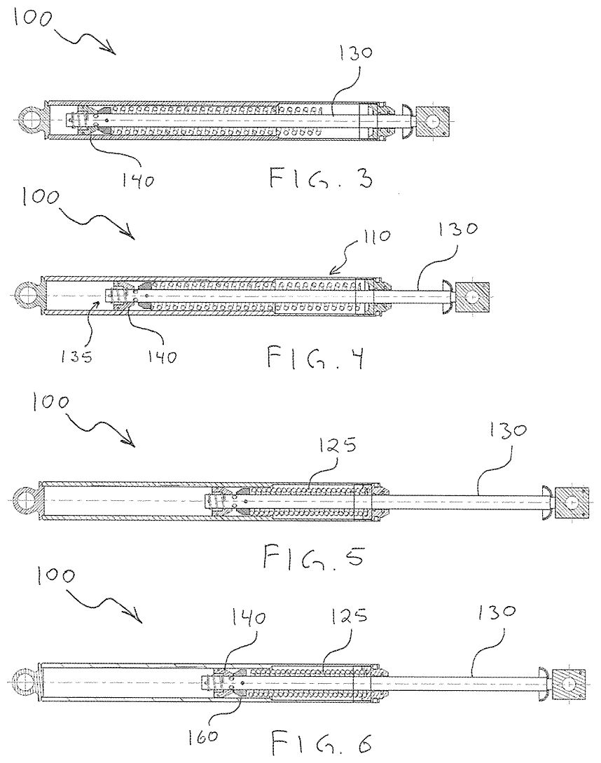

FIGS. 3, 4, 5 and 6 are further partial cross section views of the linear motion dampening system 100, illustrating an opening and closing operation of the system 100. For example, consider the operation of the system 100 installed on a swing gate (not shown) that is opened against the force of gravity, such as by a mechanical or electrical actuator, and where the swing gate is closed with the force of gravity. Thus in this example the linear motion dampening system 100 is fully closed (per FIG. 3) when the swing gate is fully closed; and the linear motion dampening system 100 is fully opened (per FIG. 5) when the swing gate is fully opened.

FIG. 3 shows the linear motion dampening system 100 in a fully closed position, where the ram shaft 130 is fully received inside the ram barrel 105. In this position, the bias spring 150 holds the ram piston 140 against the bushing 160 and closes the port holes 145. As described above, when the system 100 is in this position an associated swing gate or boom gate is also fully closed.

FIG. 4 shows the linear motion dampening system 100 as it begins to open under the force of a mechanical or electrical actuator that begins to open the associated swing gate or boom gate. Fluid, such as hydraulic fluid, contained in the fluid reservoir end 110 of the ram barrel 105 is forced around the bushing 160 and pushes the ram piston 140 toward the distal end 135 of the ram shaft 130. That opens the port holes 145 and enables the fluid to flow freely through the port holes 145 and out the hole in the distal end 135 of the ram shaft 130. There is thus relatively little resistance applied by the ram piston 140 to movement of the ram shaft 130, which enables the associated swing gate or boom gate to open without substantial resistance from the linear motion dampening system 100.

FIG. 5 shows the linear motion dampening system 100 when it is fully open under the force of the mechanical or electrical actuator that has fully opened the associated swing gate or boom gate. In this position the coil spring 125 has been compressed, which enables the system 100 to assist in smoothly stopping the associated swing gate or boom gate in a fully opened position.

Those skilled in the art will appreciate that the final few degrees, such as the final five degrees or less, of opening of an associated swing gate or boom gate may be achieved in an “over centre” position, where the force of gravity no longer acts against the opening of the gate but rather acts to further open the gate and assists in maintaining the gate in a fully open position.

FIG. 6 shows the linear motion dampening system 100 in a fully open position and where the system 100 is just beginning to be closed by the mechanical or electrical actuator, or by the force of the coil spring 125 alone. In this position the compressed coil spring 125 acts to assist in closing the system 100 and the associated swing gate or boom gate. Movement of the ram shaft 130 into the ram barrel 105 causes the hydraulic fluid to push the ram piston 140 against the bushing 160 and thus closes the port holes 145. Hydraulic fluid then can no longer flow through the port holes 145 but rather is forced around the ram piston rings 155 from the tapered end 115 of the ram barrel 105 and into the fluid reservoir end 110 of the ram barrel 105.

The ram piston 140 thus is enabled to provide significant force that resists the entry of the ram piston 140 into the ram barrel 105, and this resists the closing of the associated swing gate or boom gate. Because an inner diameter of the tapered end 115 of the ram barrel 105 is tapered from a greater value nearer the fluid reservoir end 110 to a smaller value nearer the end cap 120, the force on the ram piston gradually increases as the ram piston 140 travels into the ram barrel 105. That is because hydraulic oil can flow around the ram piston rings 155 more easily where the inner diameter of the ram barrel 105 is greater.

Therefore relatively less force is applied against the closing of the associated swing gate or boom gate as the gate begins to close under the force of gravity, and then relatively greater force is applied as the gate closes further. Under most swing gate designs, the physics of the “moment arm” of the gate under the force of gravity will result in greater torque being applied at a hinge point of the gate when the gate is nearly closed in a horizontal position than when it is fully open in a vertical position. The relatively greater force applied to the ram piston 140 when the gate is nearly closed thus is balanced against the increased moment arm of the gate. The result is that the system 100 can be tuned to enable an associated gate to close at a constant or near constant rate, or at any desired controlled rate.

Although the present description refers to hydraulic fluid, those skilled in the art will appreciate that alternative embodiments of the present invention can operate either hydraulically or pneumatically and thus the fluid can include a gas such as air.

Those skilled in the art will appreciate that various embodiments of the present invention can be made of various materials, or a combination of various materials, including aluminium, steel, metal alloys or high strength plastics or composites, and rubber or polymer seals.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

We claim:

1. A linear motion dampening system, comprising:
a ram barrel having a fluid reservoir end and a tapered end closed by an end cap;
a coil spring positioned inside the ram barrel;
a ram shaft having a distal end that is slidable inside the tapered end of the ram barrel, the ram shaft extending through the coil spring and outward from the fluid reservoir end of the ram barrel; and
a ram piston slidably attached to the distal end of the ram shaft;
wherein an inner diameter of the tapered end of the ram barrel is tapered from a greater value nearer the fluid reservoir end to a smaller value nearer the end cap.

2. The linear motion dampening system of claim 1, wherein the ram shaft includes port holes extending from a side of the ram shaft to the distal end of the ram shaft, wherein in a first position the ram piston seals the port holes and in a second position the ram piston does not seal the port holes.

3. The linear motion dampening system of claim 2, wherein a bias spring biases the ram piston in the first position that seals the port holes.

4. The linear motion dampening system of claim 1, wherein a tapered section of the tapered end of the ram barrel extends for at least one third of a total length of the ram barrel.

5. The linear motion dampening system of claim 1, wherein a tapered section of the tapered end of the ram barrel extends for at least one half of a total length of the ram barrel.

6. The linear motion dampening system of claim 1, wherein a bushing is secured to the ram shaft adjacent to the ram piston.

7. The linear motion dampening system of claim 6, wherein the coil spring is compressed by the bushing and the fluid reservoir end of the ram barrel.

8. The linear motion dampening system of claim 1, wherein a first lug is connected to the ram shaft at the fluid reservoir end and a second lug is connected to the ram barrel at the tapered end.

9. The linear motion dampening system of claim 1, wherein the ram piston includes at least one piston ring.

10. The linear motion dampening system of claim 1, wherein a ram cap covers the fluid reservoir end of the ram barrel and includes a vent hole.

11. The linear motion dampening system of claim 1, wherein the ram barrel is filled with hydraulic fluid.
